(19) United States
(12) Patent Application Publication
(10) Pub. No.: US 2007/0153101 A1
(43) Pub. Date: Jul. 5, 2007

(54) Image processing system and method thereof

(75) Inventors: Ching-Yen Chang, Hsinchu City (TW); Li Fung Cheung, Hsinchu City (TW); Shuei-Lin Chen, Hsinchu City (TW)

Correspondence Address: BACON & THOMAS, PLLC, 625 SLATERS LANE, FOURTH FLOOR, ALEXANDRIA, VA, 22314, US

(73) Assignee: ALTEK CORPORATION, Hsinchu City (TW)

(21) Appl. No.: 11/636,989

(22) Filed: Dec. 12, 2006

(30) Foreign Application Priority Data
Dec. 30, 2005 (TW) 094147418

(51) Int. Cl. H04N 5/262

(52) U.S. Cl. 348/240.2

(57) ABSTRACT

An image processing system and method thereof for a digital camera are disclosed. The image processing system comprises a sweep control unit, a line extend control unit and a WOI control unit. When the output time of a digital image needs to be prolonged, the line extend control unit will be triggered in order to extend the processing time of the digital image.

### BACKGROUND OF THE INVENTION

1. Field of Invention

The present invention relates to an image processing system and method thereof for a digital camera, and more particularly, to an image processing system and method thereof for controlling the duration of the image output.

2. Description of the Related Art

Generally speaking, a digital camera is capable of performing motional or stationary image magnification. When the digital camera performs motional image magnification, an image displaying unit (e.g. LCD) must display a specific quantity of images per second in order to prevent the generation of noise signals and the effect of residual images. This requirement constrains an image capturing unit (e.g. CCD) since it must output every row of the image to the image displaying module within a specific time frame. Moreover, in the image magnification process of prior technologies, an image processing unit must reserve a specific amount of bandwidth for the image magnification process, and a larger bandwidth reservation is required for a higher rating magnification process.

However, in the prior technologies, the individual process of the image magnification process could not be delayed. That is, it is not able to delay in between processes when an image is being captured, converted, processed, magnified, temporarily stored and displayed. Consequently, when prior technologies proceed with the image magnification process especially during high-rating magnification, there is usually bandwidth insufficiency resulting to failure in processing images on time, thus generating noise signals as well as the effect of residual images.

To solve the above mentioned problems, prior technologies have disclosed a method on increasing the bandwidth of the processing chip and reducing the refreshing rate of the magnified image. However, increasing the bandwidth of the processing chip also increases the electricity consumption of the digital camera. Furthermore, reducing the refreshing rate of the magnified image leads to reduction of image clarity.

Therefore, it is necessary to provide a new image processing system and method thereof to solve the aforementioned problems.

### SUMMARY OF THE INVENTION

The main objective of the present invention is to provide an image processing system and method thereof for magnifying digital images, which eliminates the requirement of increasing a temporary image storage memory, a chip's bandwidth or a clock's frequency, and still be able to maintain a specific image refreshing rate and prevents the generation of noise signals and the effect of residual images.

To achieve the above objectives, the present invention provides an image processing system comprising: an image capturing unit which captures an original image and converts the original image into digital image format; an image control unit for executing image conversion process, which converts the digital image into a pre-determined magnifying digital image and also to control the processing sequence on the pre-determined magnifying digital image; and an image magnification unit for magnifying the pre-determined magnifying digital image and converting it into a magnified digital image.

Wherein, the image control unit comprises: a sweep control unit for reducing the amount of horizontal data of the digital image; a line extension control unit used for controlling the output duration for each row of the digital image; a Window of Interest (WOI) control unit for reducing the amount of vertical data of the digital image.

In addition, the present invention provides an image processing method comprising the following steps: converting a digital image into a pre-determined magnifying digital image via an image converting process; converting the pre-determined magnifying digital image into a magnified digital image via an image magnification process; determining if an output duration needs to be extended, and if an extension is required, an output duration extension mechanism will be executed.

Through the above mentioned image processing system and method thereof, chip electricity consumption can be reduced and image noise signals are prevented during the digital image magnification process.

### BRIEF DESCRIPTION OF THE DRAWINGS

FIG. 1 is a structural block diagram of an image processing system in accordance with the present invention.

FIG. 2 is a structural block diagram of an image control unit in accordance with the present invention.

FIG. 3 is a flow diagram of an image processing method in accordance with the present invention.

### DETAILED DESCRIPTION OF THE PREFERRED EMBODIMENT

Other advantages and innovative features of the invention will become more apparent from the following detailed description when taken in conjunction with the accompanying drawings.

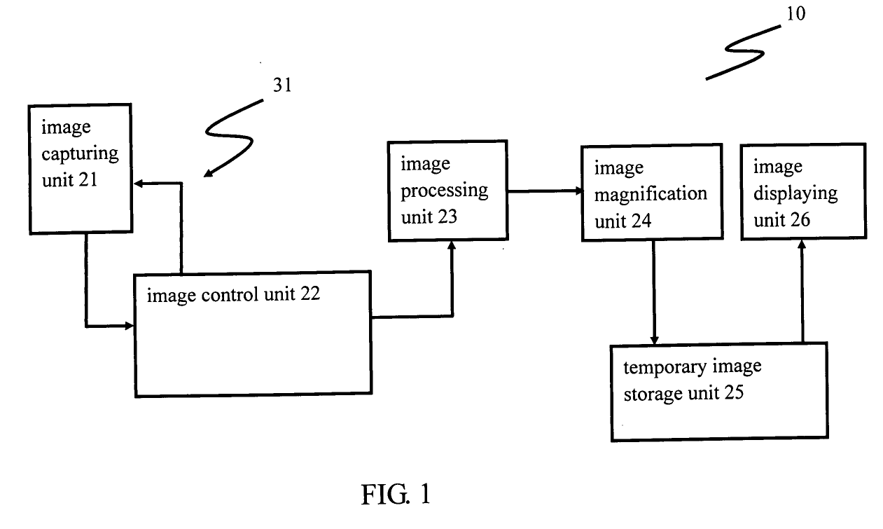

Please refer to FIG. 1, which shows a structural block diagram of an image processing system in accordance with the present invention.

As indicated in FIG. 1, an image processing system 10 of the present invention comprises of the following modules which are electronically coupled with each other: an image capturing unit 21; an image control unit 22; an image processing unit 23; an image magnification unit 24; a temporary image storage unit 25; an image displaying unit 26 and a control bus 31.

The image capturing unit 21 is used for capturing an original image, and converting the original image into a digital image. The image control unit 22 is used for executing the image conversion process, which converts the digital image into a pre-determined magnifying digital image and controls the processing sequences of the pre-determined magnifying digital image. The image processing unit 23 is used for the execution of related image processes such as appearance, hue and the brightness for the pre-determined magnifying digital image. The image magnification unit 24 is used for image magnification, which magnifies the pre-determined magnifying digital image, and converting it into a magnified digital image. The temporary image storage unit 25 is used for the storage of the magnified digital image. The image displaying unit 26 is used for displaying the magnified digital image. Furthermore, the control bus 31 is used for controlling the image control unit 22.

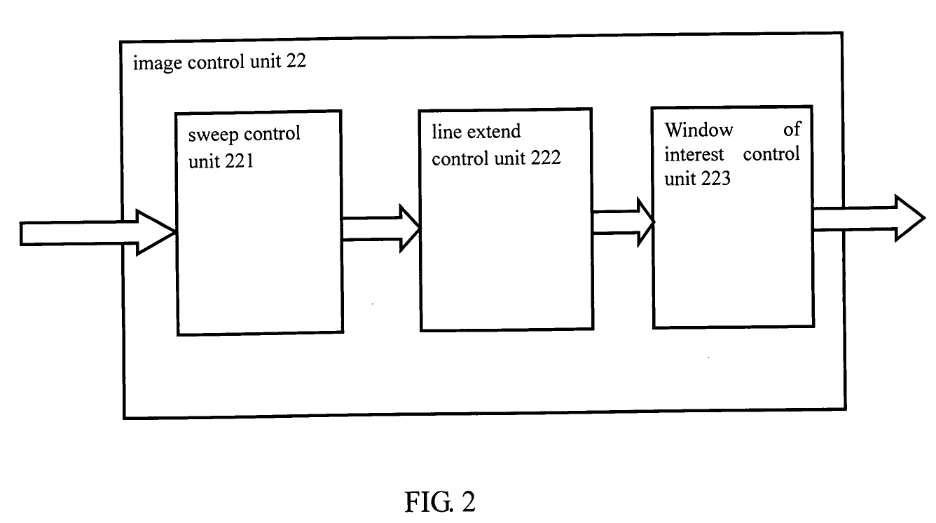

Next, refer to FIG. 2 for a structural diagram of the image control unit 22 in accordance with the present invention. As depicted in FIG. 2, the image control unit 22 comprises: a sweep control unit 221, a line extend control unit 222 and a window of interest (WOI) control unit 223. Wherein, the sweep control unit 221 is used for reducing the amount of horizontal data of the digital image. The line extend control unit 222 is used for controlling the output duration for each row of the image. The WOI control unit 223 is used for reducing the vertical data volume of the digital image, enabling the generation of the pre-determined magnifying digital image. Moreover, the sweep control unit 221, the line extend control unit 222 and the WOI control unit 223 are electronically coupled with each other. Furthermore, the control bus 31 is used for controlling the line extend control unit 222 of the image control unit 22.

In one embodiment of this invention, the image capturing unit 21 can be a CCD, a CMOS or the like. The image control unit 22, the image processing unit 23 and the image magnification unit 24 can be constructed through software, circuitry and/or hardware installation. Random access memory (RAM) is the preferred component for temporary image storage unit 25, but the present invention is not limited to this component. Liquid crystal display (LCD) is the preferred component for the image display unit 26, but the present invention is not limited to this component. Furthermore, the present invention can also perform motional or stationary image magnification.

From the structures of FIG. 1 and FIG. 2, the present invention can make use of the image processing system 10 to perform image magnification, which is able to reduce the electricity consumption by decreasing the amount of image data processed by the chip, likewise maintain a certain image refreshing rate without the need of increasing the temporary image storage memory, the chip's bandwidth nor the clock's frequency, and thus also preventing the generation of noise signals and the effect of residual images.

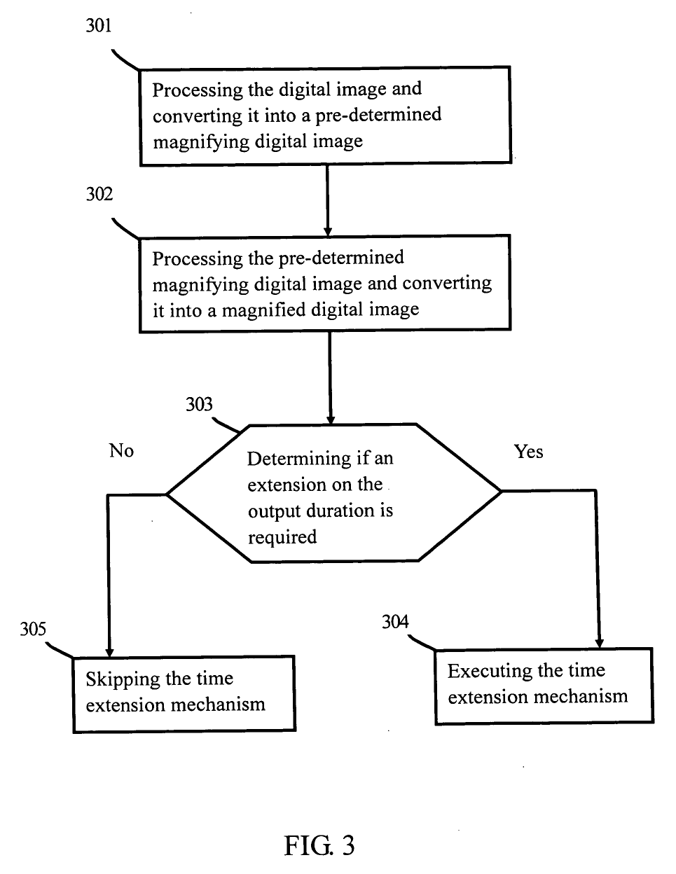

Furthermore, the present invention provides an image processing method, which is used to magnify an image for a digital camera. Please refer to FIG. 3 for a flow diagram of an image processing method in accordance with the present invention.

As depicted in FIG. 3, the present invention first proceeds with step 301, which processes the digital image and converts it into a pre-determined magnifying digital image. In step 301, the sweep control unit 221 of the present invention, as depicted in FIG. 2, reduces the amount of horizontal data of the digital image; then the reduced image data passes through the line extend control unit 222 which controls the output duration for every row of the image; then it uses the WOI control unit 223 to reduces the amount of vertical data of the digital image, which then outputs the pre-determined magnifying digital image that is reduced in data volume and consisted of necessary calculations.

Next, the present invention proceeds with step 302, which processes the pre-determined magnifying digital image and converts it into a magnified digital image. In step 302, the image processing unit 23 is executed by the present invention, which performs image processes such as appearance, hue and the brightness for the pre-determined magnifying digital image, and then the pre-determined magnifying digital image is transformed into a magnified digital image via the image magnification unit 24.

The present invention then proceeds with step 303, which determines if an extension on the output duration is required. Wherein, if bandwidth insufficiency has occurred during the magnified digital image transferred from the image magnifying unit 24 to the temporary image storage unit 25, the magnified digital image will require a greater bandwidth, and image processing will neither be in time thus triggering the need to prolong the output duration.

When an extension of the output duration is required, the present invention proceeds with step 304. It executes the time extension mechanism and uses the control bus 31 to control the line extend control unit 222, which is inside the image control unit 22, to delay the output of digital image data. When the situation of extending the output duration has been solved, the control bus 31 will again control the line extend control unit 222, and continues with the output of the digital image data.

If an extension on the output duration is not required, the present invention proceeds with step 305 and skips the time extension mechanism. It instead stores the magnified digital image directly into the temporary image storage unit 25, which is then displayed via the image displaying unit 26.

Although the present invention has been explained in relation to its preferred embodiment, it is to be understood that many other possible modifications and variations can be made without departing from the principle and scope of the invention as hereinafter claimed.

What is claimed is:

1. An image processing system which provides a magnifying process for a digital image of a digital camera, the image processing system comprising:
an image capturing unit that captures an original image and converts the original image into a digital image;
an image control unit for executing an image conversion process, which converts the digital image into a pre-determined magnifying digital image and controls the processing sequence on the pre-determined magnifying digital image, the image control unit includes a sweep control unit for reducing the amount of horizontal data of the digital image, and produces the pre-determined magnifying digital image;
an image magnification unit for magnifying the pre-determined magnifying digital image, and converting it into a magnified digital image;
a temporary image storage unit for storing the magnified digital image; and
an image displaying unit that displays the magnified digital image;
wherein the image capturing unit, the image control unit, the image magnification unit, the temporary image storage unit and the image displaying unit are electronically coupled with each other.

2. The image processing system as claimed in claim 1, wherein the image control unit comprises: a line extension control unit used for controlling the output duration for each row of the digital image, enabling the generation of the pre-determined magnifying digital image.

3. The image processing system as claimed in claim 2, wherein the image control unit comprises: a Window of Interest (WOI) control unit for reducing the amount of vertical data of the digital image, enabling the generation of the pre-determined magnifying digital image.

4. The image processing system as claimed in claim 2, further comprising a control bus for controlling the line extension control unit.

5. An image processing method which provides a magnifying process for a digital image of a digital camera, the image processing method comprising the following steps:
converting a digital image into a pre-determined magnifying digital image via an image converting process;
converting the pre-determined magnifying digital image into a magnified digital image via an image magnification process; and
determine if an extension on the output duration is required, and if the extension is required, the output of the pre-determined magnifying image will be delayed.

6. The image processing method as claimed in claim 5, wherein the image converting process further comprises the following step:
reducing the amount of horizontal data of the digital image, to enable the generation of the pre-determined magnifying digital image.

7. The image processing method as claimed in claim 6, wherein the image converting process further comprises the following step:
controlling the output duration for each row of the digital image, to enable the generation of the pre-determined magnifying digital image.

8. The image processing method as claimed in claim 7, wherein the image converting process further comprises the following step:
reducing the amount of vertical data, to enable the generation of the pre-determined magnifying digital image.

9. The image processing method as claimed in claim 5, wherein the step of extending the output duration refers to the situation when the output of the magnified digital image induces the magnification process to experience insufficient processing time of magnifying the digital image, and requires delaying the output of the magnified digital image.
